(19) United States
(12) Patent Application Publication
(10) Pub. No.: US 2025/0348402 A1
(43) Pub. Date: Nov. 13, 2025

(54) SYSTEMS AND METHODS FOR ANALYZING THE EFFECTIVENESS OF CHAT BOTS

(71) Applicant: NICE LTD., Ra'anana (IL)

(72) Inventors: Nitin NAZARE, Pune (IN); Mukesh Kumar AGARWAL, Pune (IN); Hitesh MADNANI, Pune (IN); Digambar KUMAR, Jamui (IN); Bhagyashree BHOYAR, Pune (IN)

(73) Assignee: NICE LTD., Ra'anana (IL)

(21) Appl. No.: 18/662,254

(22) Filed: May 13, 2024

(51) Int. Cl. G06F 11/34; G06F 11/30

(52) U.S. Cl. CPC G06F 11/3409; G06F 11/302; G06F 2201/81; G06F 2201/865

(57) ABSTRACT

Systems and methods for monitoring a performance of a chat bot include: analysing, by an artificial intelligence (AI) module, a transcript of at least one conversation in which the chat bot participates; identifying, by the AI module, one or more skills of the chat bot where performance falls below a pre-defined performance threshold; determining a chat bot effectiveness score; and determining whether to: automatically update a set of predefined responses of the chat bot based on at least one of: the one or more identified skills; and the chat bot effectiveness score; else, outputting an indication of the one or more identified skills and the chat bot effectiveness score.

### FIELD OF THE INVENTION

The present invention relates generally to automated computer chat bots, in particular to monitoring a performance of a chat bot using a chat bot effectiveness score.

### BACKGROUND OF THE INVENTION

Typically, chat bots, such as virtual chat bots implemented as automated computer processes, have a limited set of responses, and may be unable to answer multi-part questions or questions that require decisions. This can result in customers being left without a solution or needing to be redirected to a live agent.

Additionally, chat bots typically have limitations in relation to not being able to address personalized customer issues, or failing to understand customer emotion and intent. However, it is typically not easy or practical to monitor every chat bot conversation to understand how the chat bot is performing.

Accordingly, there is a need in the art to monitor the performance of one or more chat bots.

### SUMMARY

Embodiments of the invention include a method for monitoring a performance of a chat bot, including: analysing, by an artificial intelligence (AI) module, a transcript of at least one conversation in which the chat bot participates; identifying, by the AI module, one or more skills of the chat bot where performance of the skills falls below a pre-defined performance threshold; determining a chat bot effectiveness score; and determining whether to: automatically update a set of predefined responses of the chat bot based on at least one of: the one or more identified skills; and the chat bot effectiveness score; else, outputting an indication of the one or more identified skills and the chat bot effectiveness score.

According to some embodiments, the chat bot effectiveness score is based on at least one parameter of the chat bot selected from the list including: an average conversation length (CL); an interaction rate (IR); a total number of conversations (TC); a total number of engaged conversations (EC); a total number of unique users (UU); a missed messages (MM) parameter; a human takeover rate (TR); a goal completion rate (CR); a customer satisfaction score (CS); and/or an average response time (RT).

According to some embodiments, the chat bot effectiveness score is based at least in part on or defined per EQN. 1 herein, wherein k is an index of a conversation of a total number of conversations of the chat bot.

According to some embodiments, at least one parameter of the chat bot includes a rating value determined based on a predefined range of rating values.

According to some embodiments, at least one rating value is weighted based on a predefined range of weighting values.

According to some embodiments, the method includes generating, by the AI module, one or more recommended responses to be added to the set of predefined responses, or for updating a response of the set of predefined responses.

According to some embodiments, the method includes reformatting the transcript of the at least one conversation of the chat bot prior to analysing by the AI module.

According to one or more embodiments, there is provided a system for monitoring a performance of a chat bot, the system including: at least one computer processor; and a memory containing instructions which, when executed by the at least one computer processor, cause the at least one computer processor to: analyze, by executing an artificial intelligence (AI) module, a transcript of at least one conversation of the chat bot; identify, by executing the AI module, one or more skills of the chat bot where performance of the skills falls below a pre-defined performance threshold; determine a chat bot effectiveness score; and determine whether to: automatically update a set of predefined responses of the chat bot based on at least one of: the one or more identified skills; and the chat bot effectiveness score; else, output an indication of the one or more identified skills and the chat bot effectiveness score.

According to some embodiments, the chat bot effectiveness score is based on at least one parameter of the chat bot selected from the list including: an average conversation length (CL); an interaction rate (IR); a total number of conversations (TC); a total number of engaged conversations (EC); a total number of unique users (UU); a missed messages (MM) parameter; a human takeover rate (TR); a goal completion rate (CR); a customer satisfaction score (CS); and/or an average response time (RT).

According to some embodiments, the at least one computer processor is configured to determine the chat bot effectiveness score as given in EQN. 1, wherein k is an index of a conversation of a total number of conversations of the chat bot.

According to some embodiments, at least one parameter of the chat bot includes a rating value determined based on a predefined range of rating values.

According to some embodiments, at least one rating value is weighted based on a predefined range of weighting values.

According to some embodiments, the at least one computer processor is configured to generate, by executing the AI module, one or more recommended responses to be added to the set of predefined responses, or for updating a response of the set of predefined responses.

According to some embodiments, the at least one computer processor is configured to reformat the transcript of the at least one conversation of the chat bot prior to analysing.

According to one or more embodiments, a method for monitoring an effectiveness of a chat bot includes: determining, using artificial intelligence (AI) and based on a conversation of the chat bot, a desired area of improvement of the chat bot; calculating a chat bot effectiveness score; and automatically updating a set of knowledge base articles of the chat bot based on a predefined threshold of the chat bot effectiveness score.

According to some embodiments, the determined desired area of improvement is determined based on an intent of a user of the chat bot to which the transcript pertains.

According to some embodiments, the step of automatically updating includes generating, by the AI, a replacement knowledge base article based on the determined desired area of improvement.

According to some embodiments, calculating the chat bot effectiveness score includes determining a representative value for one or more parameters of the chat bot.

According to some embodiments, the one or more parameters includes at least one of: an average conversation length (CL); an interaction rate (IR); a total number of conversations (TC); a total number of engaged conversations (EC); a total number of unique users (UU); a missed messages (MM) parameter; a human takeover rate (TR); a goal completion rate (CR); a customer satisfaction score (CS); and/or an average response time (RT).

According to some embodiments, calculating the chat bot effectiveness score includes summing the determined representative values.

### BRIEF DESCRIPTION OF THE DRAWINGS

Non-limiting examples of embodiments of the disclosure are described below with reference to figures attached hereto. The dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 shows example stages of a plurality of conversations of a chat bot, such as a virtual chat bot for booking flights;

FIG. 2A shows an example schematic view of elements involved in a method and/or system for monitoring a performance of a chat bot, according to some embodiments of the invention;

FIG. 2B shows an example management of transcripts, for example as performed by a transcript manager, according to some embodiments of the invention;

FIG. 2C shows example functions of an intent analyzer, according to some embodiments of the invention;

FIG. 2D shows an example output of a generative AI (gen AI), according to some embodiments of the invention;

FIG. 3 shows example parameters of a chat bot, as monitored according to some embodiments of the invention;

FIG. 4 shows a flowchart of a method for monitoring a performance of a chat bot, according to some embodiments of the invention;

FIG. 5 shows an example data representation for determining automatic actions, according to some embodiments of the invention;

FIG. 6 shows example predefined ranges of rating values and weights, according to some embodiments of the invention;

FIG. 7 shows a schematic example of how a score may be used, according to some embodiments of the invention; and

FIG. 8 a block diagram of an exemplary computing device which may be used with embodiments of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Embodiments of the invention relate generally to chat bots, in particular to monitoring a performance of a chat bot using a chat bot effectiveness score.

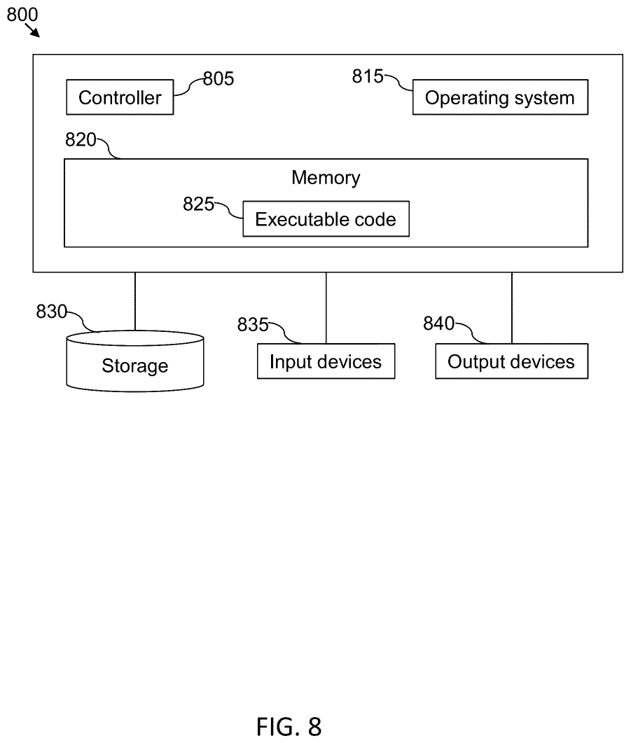

A chat bot may be a virtual chat bot, for example a virtual agent. The terms chat bot and virtual chat bot may be used interchangeably herein. A chat bot may be a computerized process (e.g. executed by a system such as in FIG. 8) mimicking human conversation through text or voice interactions, often using natural language processing (NLP) and/or generative artificial intelligence (AI), and/or deep learning. Chat bots may be used in interactions (such as online conversations) with customers, for example by answering queries, making reservations, and/or providing information. Responses of a chat bot may be predefined based on a set of knowledge base articles in a knowledge base of the chat bot. The knowledge base may be, for example, a database of knowledge base articles, which may include a plurality of predefined instructions, prompts, or information which the chat bot uses to formulate responses and/or replies.

A single chat bot may be capable of holding multiple simultaneous conversations with a plurality of customers. As an example, a single chat bot may engage in tens, hundreds, or thousands of conversations a day. It can thus be impractical to manually analyze the performance of a chat bot by reading a transcript and manually identifying areas in which the chat bot requires improvement.

Methods and systems disclosed herein may relate to a single chat bot of a given type (e.g. booking agent), multiple chat bots of the given type, or different chat bots of different types (e.g. booking agent, order tracking agent).

A chat bot may be capable of providing more than one type of service. For example the same chat bot may be able to handle general customer queries and also take online orders for goods or services.

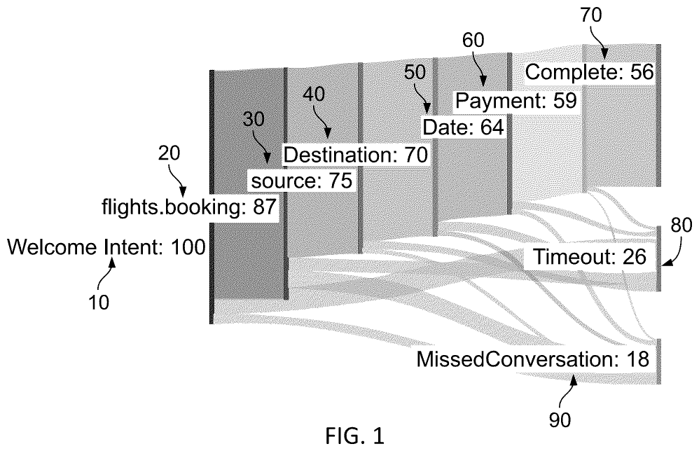

FIG. 1 shows example stages of a plurality of conversations of a chat bot, such as a virtual chat bot for booking flights. The stages may include a welcome intent stage 10, a flights booking stage 20, a source stage 30, a destination stage 40, a date stage 50, a payment stage 60, a completion stage 70, and breakout stages which may include timeout stage 80 and missed conversation stage 90.

In FIG. 1, 100 total conversations the chat bot participates in are shown for the selected time frame, each initiated by a welcome intent 10. All 100 conversations are shown as progressing through the welcome intent stage 10, because this stage is a starting stage.

In the example, only 87 conversations proceeded to flights booking stage 20, with some conversations being terminated from stage 10 due to timeout (stage 80) or missed conversations (stage 90). For example, a person at the other end of the conversation with the chat bot may not have responded for a predetermined period of time (e.g. 5 minutes), resulting in a timeout. As another example, the customer may have followed the welcome intent with a query relating to something other than flight booking which the chat bot may not have been able to understand and respond to, resulting in a missed conversation.

As shown, 75 conversations made it to source stage 30 (e.g. a starting destination for the flight booking), with some conversations terminated from previous stage 20. Proceeding to destination stage 40 (e.g. an end destination for the flight booking), 70 conversations are shown to have made it to this stage.

Date stage 50 may involve conversing with the chat bot on relevant and/or available dates for the flights. In the example data shown, 64 conversations made it to this stage, and 59 conversations proceeded to payment stage 60. Of the 100 total example conversations only 56 conversations progressed to completion stage 70, with the remaining 44 conversations shown as either breaking off into timeout stage 80 (26 conversations) or missed conversations stage 90 (18 conversations).

In some embodiments, improving the performance of a chat bot includes reducing the number of missed conversations.

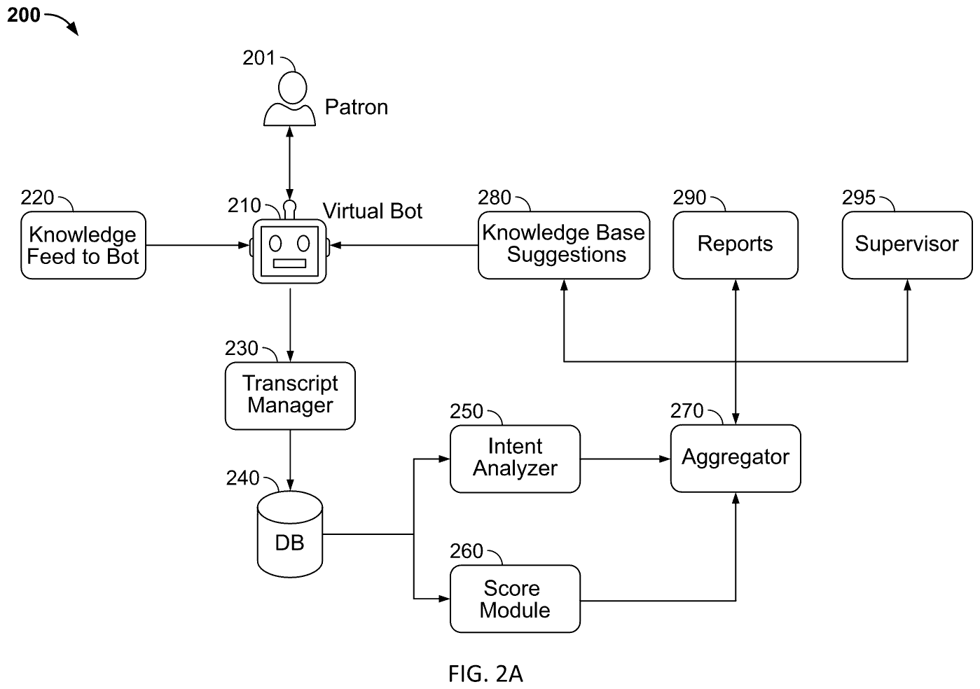

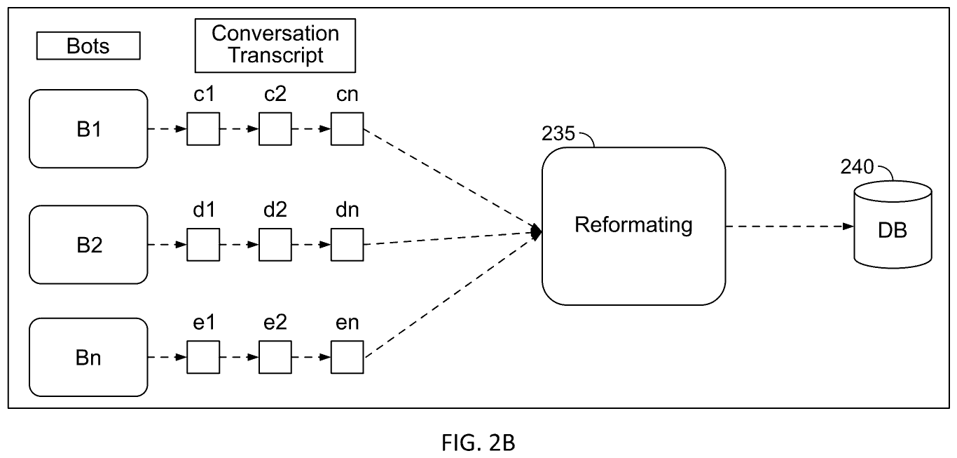

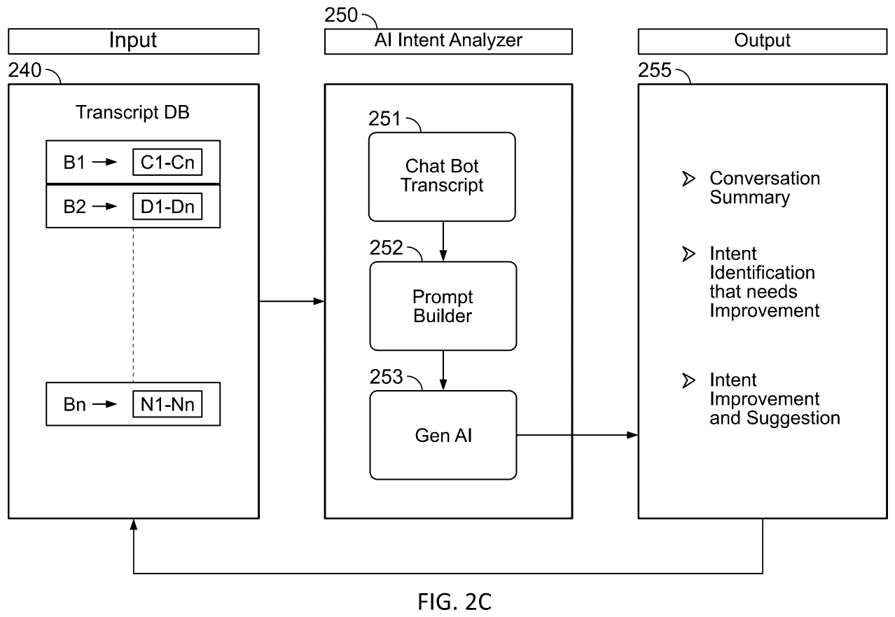

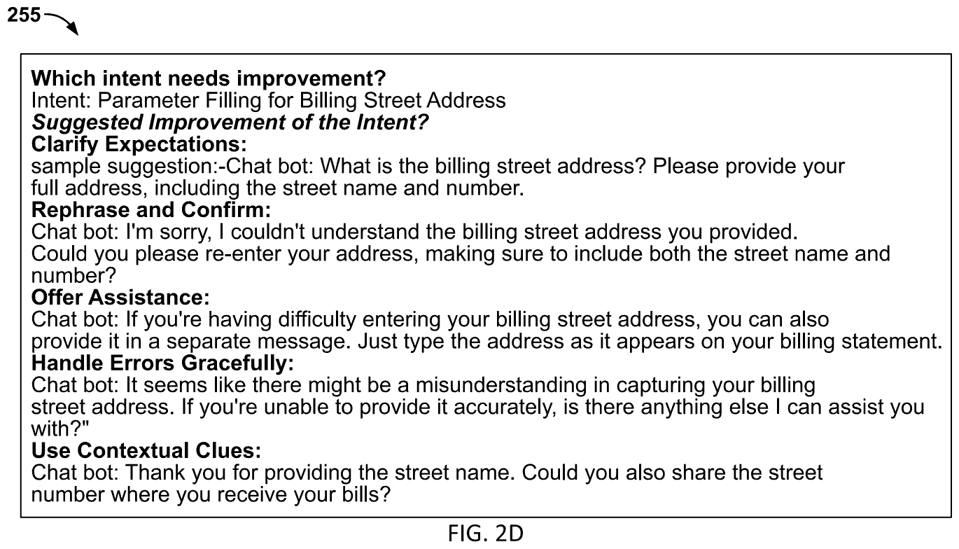

FIG. 2A shows an example schematic view 200 of elements involved in a method and/or system for monitoring a performance of a chat bot, according to some embodiments of the invention.

A patron (such as a customer) may use patron computer 201 to participate in a conversation with a chat bot 210, such as a virtual chat bot. Chat bot 210 may generate responses based on one or more knowledge base articles stored in a knowledge base or knowledge feed 220. A knowledge base article may include a predefined response to a predefined style or format of query.

A transcript manager 230 may manage one or more transcripts of chat bot 210 and may manage transcripts of one or more other chat bots. Transcripts may be stored in a database 240. Metadata relating to the transcripts may also be stored in database 240.

FIG. 2B shows an example management of transcripts, for example as performed by transcript manager 230, according to some embodiments of the invention. One or more bots B1, B2, . . . . Bn (e.g. n being an integer) may participate in one or more conversations resulting in one or more associated conversation transcripts c1, c2, . . . cn, d1, d2, . . . , dn, and/or e1, e2, . . . , en. These transcripts may be reformatted (235) by transcript manager 230. For example, the reformatting may include removing sector specific terms and/or replacing such terms with unified consistent terms for different chat bots from different sectors, in order to enable a uniform analysis of performance across different types of conversations and different types of chat bots. The reformatting may include JavaScript Object Notation (JSON) reformatting. Transcripts and/or reformatted transcripts may be stored in database 240.

Returning to FIG. 2A, an intent analyzer 250, which may be, for example, an AI-based module, may analyze a transcript of at least one conversation in which the chat bot participates, for example as stored in database 240. Further details of the intent analyzer are shown in FIG. 2C. As used herein, intent may be a representation of a goal or purpose that a user has within the context of a conversation in which the user and chat bot participate. Examples of intent may include: welcome, parameter filling, destination, payment, Small_Talk_Confirmation_Yes, or the like.

FIG. 2C shows example functions of an intent analyzer, according to some embodiments of the invention. Intent analyzer 250 may be AI-based, and may receive as input a transcript 251 of a conversation in which chat bot 210 participates. The transcript may be retrieved from database 240. The transcript may be a reformatted transcript.

AI intent analyzer 250 may include a prompt builder 252. Prompt builder 252 may use one or more principles of prompt engineering in the field of generative AI to build one or more prompts based on predefined instructions. For example, prompt builder 252 may construct one or more prompts covering questions or instructions such as: “What is the context of the conversation?”; “Summarize the conversation”; “What is the customer intent present in the transcript?”, etc.

Constructed prompts built by prompt builder 252 may be passed to a generative (gen) AI 253. Gen AI 253 may be a trained AI, such as a trained large language model (LLM) configured to generate an output, such as a textual output, based on an input prompt. For example, based on the prompt, gen AI 253 may identify one or more skills, performance areas, and/or performance metrics of the chat bot where performance falls below a pre-defined performance threshold. For example, gen AI 253 may identify from the transcript that the chat bot is not adequately (e.g. does not meet or exceeds a predefined allowable value): clarify expectations; rephrasing and confirming; offering assistance; handling errors gracefully; and/or using contextual clues.

A prompt may include a context or domain, which may be provided by the chat bot provider, or otherwise contained in metadata relating to the chat bot. For example, a prompt may start as follows: “You are a supervisor, you are doing an assessment of the conversation of the customer with a bot for {domain} and based on the assessment, you will need to provide suggestions on how to improve”. In this example prompt, the context may be that the gen AI should assume the role of a supervisor assessing a conversation. The domain may be, for example, a customer service domain, such as flight booking, complaint handling, shipping queries, or the like.

Based on the built prompt, the gen AI may output its findings as an output 255. The output 255 may in general include a conversation summary, an intent identification that needs improvement, and/or an intent improvement suggestion. Output 255 may be stored in a JavaScript Object Notation (JSON) format. Other formats may be used.

FIG. 2D shows an example output of a generative AI (gen AI), according to some embodiments of the invention. The prompt is also shown as part of the output, for example, the prompt in this example included “Which intent needs improvement?”. The AI analyzer identified parameter filling for billing street address as the intent/performance area requiring improvement. A second part of the prompt asked the gen AI for suggestions on improving the intent, and output 255 shows one or more recommended responses generated by the gen AI which may be added to the set of predefined responses (e.g. knowledge base articles), or for updating a response of the set of predefined responses.

Returning to FIG. 2A, there may be a score module 260. Score module 260 may be configured to determine a chat bot effectiveness score. For example, the score module may be, or may include, a computer processor (Such as shown in FIG. 8 herein) which may determine, derive, evaluate or otherwise calculate a chat bot effectiveness score based on one or more parameters. The one or more parameters may measure or characterize, directly or indirectly, one or more chat bot skills, performance areas, and/or predefined performance metrics. Accordingly, the chat bot effectiveness score may measure or characterize, directly or indirectly, one or more chat bot skills, and thus provide an indication of the performance of the chat bot that can be monitored over time to identify changes in performance.

For example, the chat bot effectiveness score may be based on at least one parameter of the chat bot such as for example: an average conversation length (CL); an interaction rate (IR); a total number of conversations (TC); a total number of engaged conversations (EC); a total number of unique users (UU); a missed messages (MM) parameter; a human takeover rate (TR); a goal completion rate (CR); a customer satisfaction score (CS); and/or an average response time (RT). Other parameters may be used.

An average conversation length (CL) may measure the number of messages exchanged, e.g. it may be a parameter or metric which indicates or is otherwise representative of how many messages the chat bot and customer are sending back and forth. An ideal conversation length may vary, for example simple queries may be easier to resolve and may take less time. Complex questions may require a higher number of back-and-forth messages between the chat bot and customer. Accordingly, average conversation length may indicate how well the chat bot performs at responding to queries.

An interaction rate (IR) may be a parameter or metric which indicates or is otherwise representative of how frequently messages are being exchanged, for example as a number of messages per unit time. A high interaction rate may show that the chat bot can hold or otherwise maintain a conversation, and may be indicative, for example, of a skill or ability of the chat bot to make small talk.

A total number of conversations (TC) may be a parameter or metric which indicates or is otherwise representative of how many times a customer opens a chat bot widget. This metric may reveal how much demand there is for the chat bot, and may help determine when and where the customers initiate requests.

A total number of engaged conversations (EC) may be a parameter or metric which indicates or is otherwise representative of interactions that continue after a welcome message. For example, comparing this metric to the number of total conversations may indicate if customers find the chat bot helpful, or are ignoring the chat bot (e.g. where the chat bot “pops up” and offers assistance).

A total number of unique users (UU) may be a parameter or metric which indicates or is otherwise representative of how many different individual people are interacting with the chat bot. For example, a single customer might have several conversations with a chat bot over the course of their customer journey (for example at different stages such as order placement, shipping enquiry, return enquiry, complaints procedure etc.). For example, comparing this metric to the total number of conversations may show how many customers talk with the chat bot more than once.

A total number of missed messages (MM) may be a parameter or metric which indicates or is otherwise representative of how often chat bot was confused, “stumped”, or otherwise unable to respond to a customer question or query. For example, each time the chat bot responds, “Sorry, I don't understand,” or similar, that is a missed message. Missed messages may result in a human takeover, e.g. a live agent assumes responsibility for the conversation.

A human takeover rate (TR) may be a parameter or metric which indicates or is otherwise representative of how often, when a chat bot cannot resolve a customer query, it escalates the request to a human (e.g. a live agent). This metric may show how much time the chat bot is saving. A takeover rate may be expressed for example in terms of a percentage of conversations, an average time into the conversation before human takeover, or a number of instances of human takeover per unit time (e.g. 3 per hour) or other manners.

A goal completion rate (CR) may be a parameter or metric which indicates or is otherwise representative of how often the chat bot helps achieve business goals. The outcomes may depend on specific objectives and may be configurable. A goal completion rate may be expressed in terms of a number of completed goals (e.g. a number of successfully booked flights) per unit time, such as 10 per hour. A goal completion rate may be expressed as a percentage, e.g. 70% of conversations with the chat bot resulted in a completed flight booking. For example, in terms of hotel reservations made through a chat bot, if the chat bot engages in 400 interactions in a day and out of those 400 interactions 80 interactions resulted in successful hotel reservations then the goal completion rate may be expressed as (80/400)*100=20%. Other manners of expressing the CR parameter may be used.

A customer satisfaction score (CS) may be a parameter or metric which indicates or is otherwise representative of a customer rating of their experience with the chat bot after finishing a conversation. For example, after concluding a conversation with a chat bot a customer may be prompted to provide a rating, such as a rating on a scale from 1 to 5, 0 to 10, a number of stars, or the like. This rating or score may be high if the customer was highly satisfied, or low if the customer was highly dissatisfied with the experience they received from the chat bot.

An average response time (RT) may be a parameter or metric which indicates or is otherwise representative of the time a customer is left waiting for their query to be picked up (e.g. a hold time). A chat bot may be able to respond to live inquiries faster than a team of live agents, for example by providing a first point of contact for customers. An average response time may be expressed in units of time, which may include seconds, minutes, and/or hours. Other manners of expressing the RT parameter may be used.

In some embodiments, the chat bot effectiveness score is for example:

$$Effectivness Score = {\sum }_{k = 0}^{TC} CL + IR + EC + UU + MM + TR + CR + CS + RT \qquad EQN . 1$$

The index k may be an index of a conversation of a total number of conversations of the chat bot. For example, the chat bot effectiveness core may iteratively sum over all conversations of the chat bot, and for each conversation calculating the sum of: an average conversation length (CL); an interaction rate (IR); a total number of engaged conversations (EC); a total number of unique users (UU); a missed messages (MM) parameter; a human takeover rate (TR); a goal completion rate (CR); a customer satisfaction score (CS); and an average response time (RT). Other definitions may be used. The score may be normalized, converted to a percentage, or expressed as a value between 0 and 1.

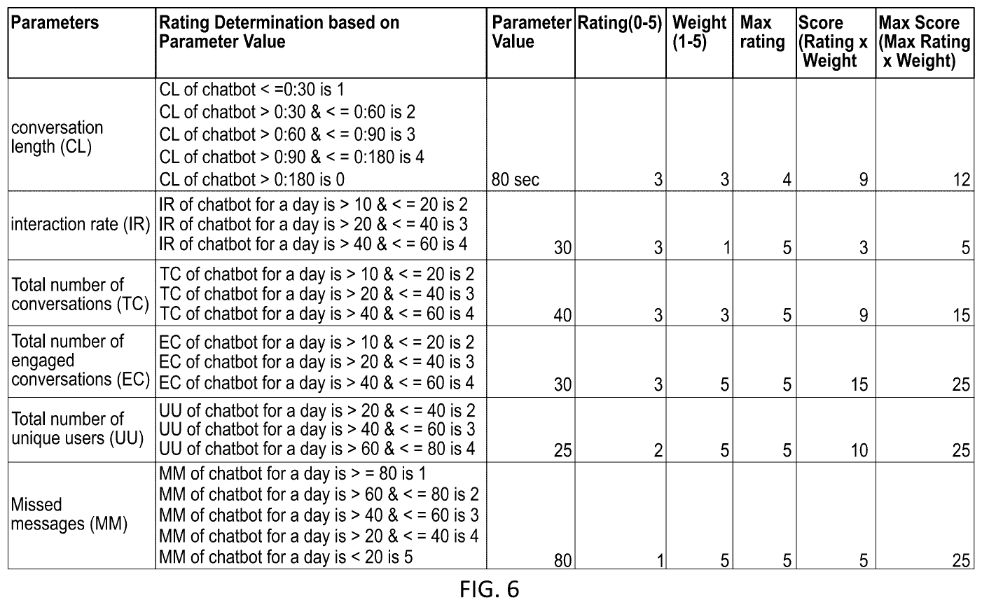

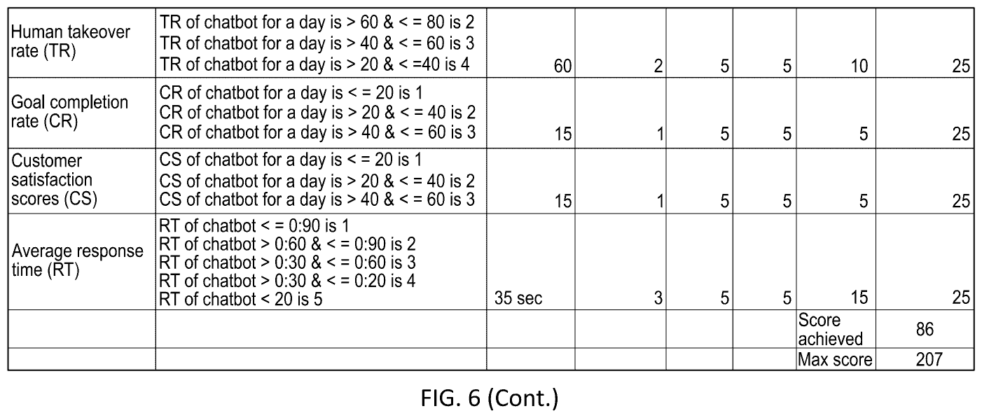

Each parameter may be represented by a rating, e.g. a banded value which may be assigned as a value representative of the parameter for use in EQN. 1 according to predefined ranges, as explained in further detail with respect to FIG. 6 herein. For example, in some embodiments, the parameters of the chat bot include a rating value determined based on a predefined range of rating values. For example, a rating may contextualize a parameter, because different parameters may be viewed as positive or negative depending on how large or small the value is, and may not be easily or directly summed in a meaningful way (e.g. summing a time parameter and a percentage parameter). As an example, a low number of missed messages (e.g. less than or equal to 2) may generally be positive, but a low customer satisfaction score (e.g. 2 out of 5 stars) may generally be negative. Thus, using absolute values of MM=2 and CS=2 may give a misleading view of the chat bot performance. Rating thresholds may be defined to address this, for example for MM example rating thresholds may include: MM<20 a day=5; 20<MM<40=4; 40<MM<60=3; 60<MM<80=2; and MM>80=1. Similarly, time-based parameters may be mapped to or assigned as a dimensionless (e.g. unitless) rating value depending on the length/duration of the time value. For example, for a conversation length (CL) parameter, a conversation lasting 38 seconds may be mapped to a rating value of 1 for a predefined rating range where CL<0:30=1. For the predefined rating range 0:90<CL<0:180=4, a conversation which lasts 100 seconds may have the CL parameter value mapped to a value of 4. Assigned ratings values (e.g. representative values) can be summed according to EQN. 1 because they are all dimensionless and help to standardize the different parameters which assess chat bot skills.

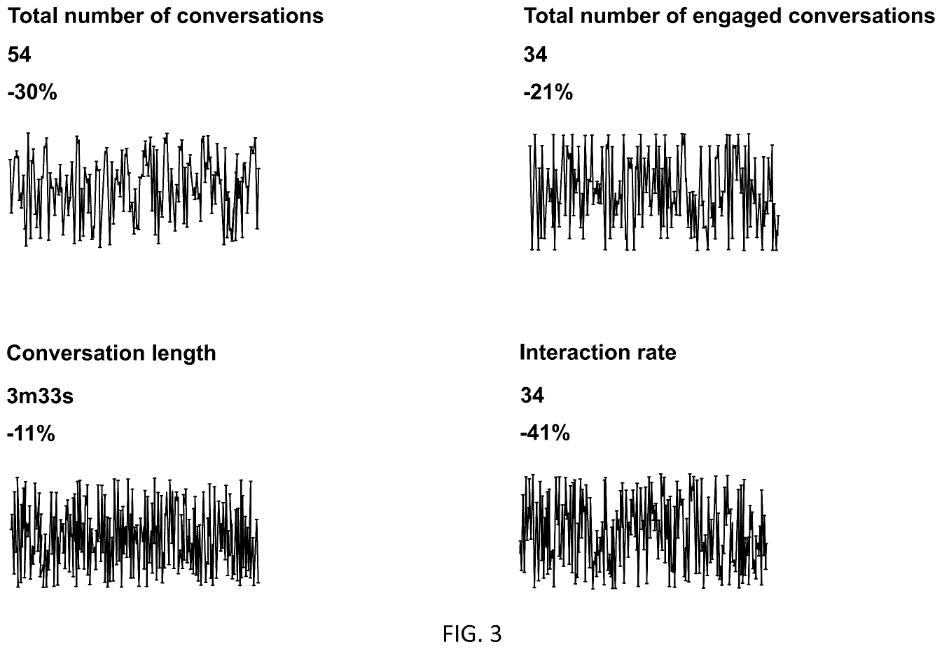

FIG. 3 shows example parameters of a chat bot, as monitored according to some embodiments of the invention. For example, parameters such as total number of conversations, total number of engaged conversations, conversation length, and/or interaction rate may be monitored. The parameters may be saved, recorded, and/or displayed using one or more visualizations, such as an absolute value in appropriate units, a percentage change in a given time period, and/or a graph or other chart showing an evolution of the parameter for the chat bot. Such visualizations may be included in a report to a supervisor.

Returning to FIG. 2A, an aggregator 270 may aggregate outputs of intent analyzer 250 and score module 260. For example, aggregator 270 may combine an output 255 as shown in FIG. 2D with a score calculated according to EQN. 1 into a single document or file, for example in the form of a report. Aggregator 270 may push or otherwise send such reports to a reports module 290, which may distribute reports to appropriate resources or personnel. For example, an aggregated report may be sent to a supervisor 295. The report may include, for example, a score and one or more individual insights into select parameters, such as shown in FIG. 3.

A chat bot may be modified or updated in various manners in response to a report, or in response to data created as discussed herein. For example, a chat bot may be retrained (e.g. retraining a NN) in response to a report. Depending on the content of an aggregate output, aggregator 270 may send, e.g. automatically, an aggregate output to a process 280 for updating knowledge base suggestions, for example as contained in an output 255 of intent analyzer 250. A supervisor may suggest knowledge base updates related to predefined skills predefined as requiring manual update. For example, aggregator 270 may automatically update a set of predefined responses of the chat bot based on at least one of: the one or more identified skills and the chat bot effectiveness score, else aggregator 270 may output an indication of the one or more identified skills and the chat bot effectiveness score, for example by outputting to a display of a supervisor.

Knowledge base article suggestions 280 may be used to update or otherwise replace knowledge base articles used in knowledge fee 220 to the chat bot, thereby refining or otherwise changing the set of predefined responses from which the chat bot can draw upon in conversation.

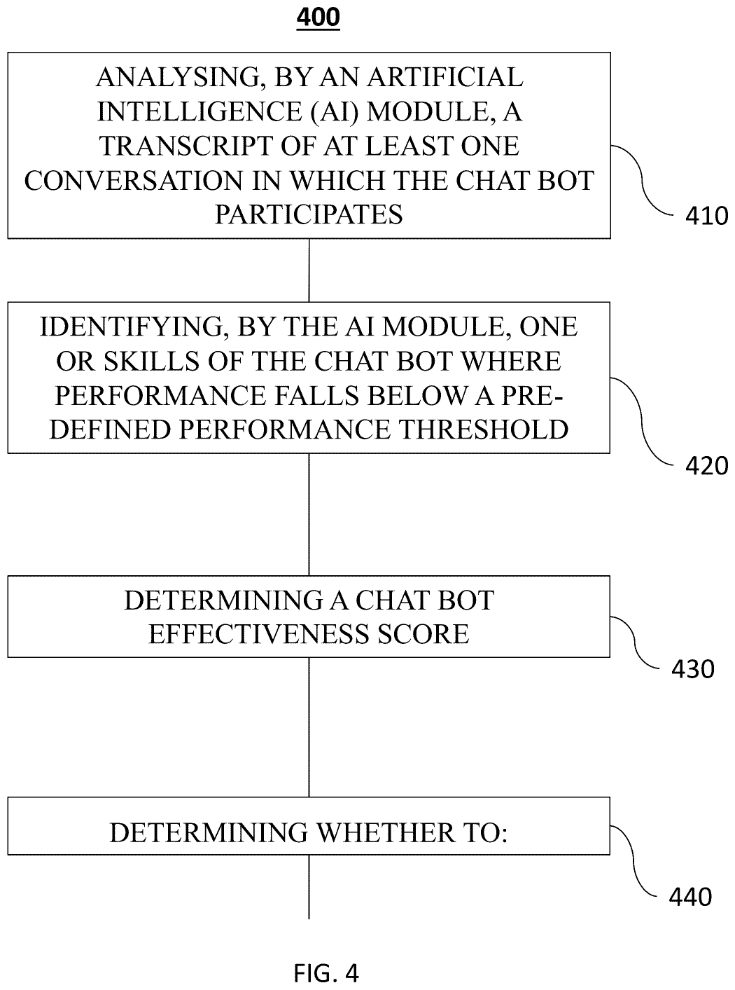

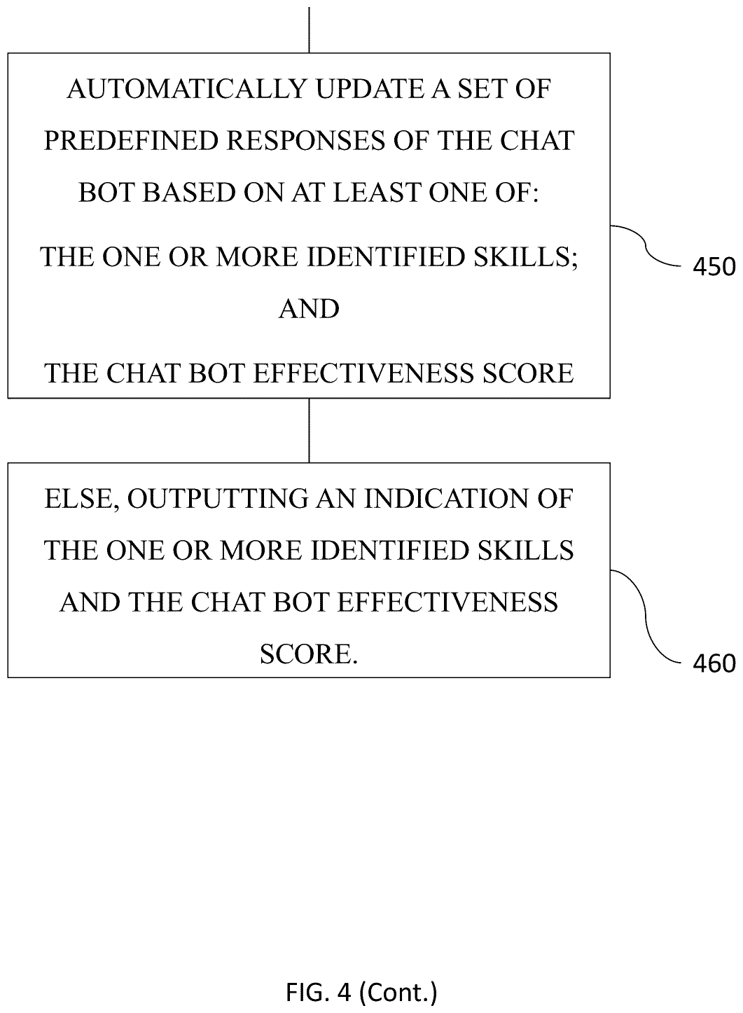

FIG. 4 shows a flowchart of a method 400 for monitoring a performance of a chat bot, according to some embodiments of the invention.

Method 400 may include analysing, by an artificial intelligence (AI) module, a transcript of at least one conversation in which the chat bot participates (Step 410). For example, a chat bot may participate in a conversation with a customer, such as a text-based exchange via a messaging widget of a company website, and a transcript of that conversation may be saved and analyzed for use in monitoring the performance of the chat bot. A conversation in which the chat bot participates may be a spoken conversation, for example a conversation over the phone between a customer and a chat bot with a speech capability. A transcript of the spoken conversation may be saved and analyzed for use in monitoring the performance of the chat bot.

Method 400 may include identifying, e.g. by the AI module, one or more skills of the chat bot where performance falls below a pre-defined performance threshold (Step 420).

An example skill may be an ability to correctly identify customer intent. If a chat bot cannot correctly identify customer intent, this may mean the chat bot requires improvement in that performance area. Another example skill may include the ability to identify or interpret values from parameter filing, for example identifying an address provided by a conversation participant, identifying dates, or the like. An example of a missed intent may include when a customer does not indicate a street address when providing the address: the intent of the customer is to give an address, but the chat bot “misses” reading the address because it cannot identify a singular address without the street address. Another example skill may include the ability to make small talk, provide follow ups (e.g. “Are you still there?”, “Do you need more help with this?”, etc.) and/or provide confirmations (e.g. “Great! That is all booked for you.”). Other skills, performance areas, and/or performance metrics may be used.

The performance of skill may fall below a pre-defined performance threshold if the number or rate (e.g. number in a given period of time) is higher than a pre-defined value. For example if the chat bot misses 6 customer intents when an acceptable threshold is pre-defined as 4 misses, the performance is worse than the threshold value, and thus the performance may be considered to fall below the pre-defined threshold.

Method 400 may include determining a chat bot effectiveness score (Step 430). For example, a computer processor may determine, derive, or otherwise calculate a chat bot effectiveness score based on one or more parameters. The chat bot effectiveness score may be calculated as described herein, for example with reference to EQN. 1. The chat bot effectiveness core may be referred to as a virtual chat bot effectiveness score, or VCBES.

The chat bot effectiveness score may be based on at least one parameter of the chat bot selected from the list including: an average conversation length (CL); an interaction rate (IR); a total number of conversations (TC); a total number of engaged conversations (EC); a total number of unique users (UU); a missed messages (MM) parameter; a human takeover rate (TR); a goal completion rate (CR); a customer satisfaction score (CS); and/or an average response time (RT), described in further detail herein. Other definitions may be used.

Method 400 may include a decision step (Step 440). For example, in operation 440 in combination with operations 450 and 460 it may be determined whether to automatically update a set of predefined responses of the chat bot (Step 450), else output an indication of the one or more identified skills and the chat bot effectiveness score (Step 460).

Step 450 of determining whether to automatically update a set of predefined responses of the chat bot may be based on at least one of the one or more identified skills and/or the chat bot effectiveness score. For example, certain skills or missed intents may relate to sensitive topics, such as payment taking, which may not be desired for automatic updates. In some embodiments, a manager may predefine which areas they approve for automatic updating, e.g. approve automatic updating of knowledge base articles and/or suggested responses relating to asking for address information, and may predefine that there should be no automatic updating for knowledge base articles and/or suggested responses which relate to payment matters.

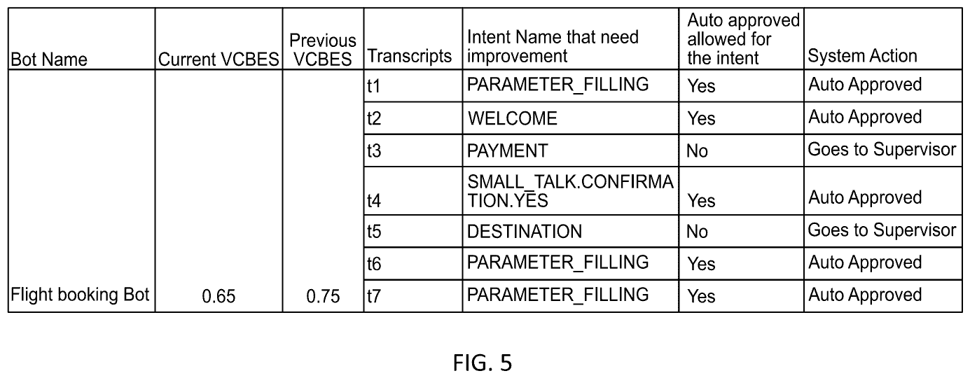

FIG. 5 shows an example data representation for determining automatic actions, according to some embodiments of the invention. In the example shown, a flight booking bot has undergone a decrease in its virtual chat bot effectiveness score (VCBES), decreasing from a previous score of 0.75 to a current score of 0.65. Accordingly, the chat bot may be monitored to identify areas of improvement. Based on transcripts from seven recent conversations of the chat bot (e.g. since the last score calculation) a number of skills/performance areas such as intents that need improving are identified. The intents that need improving may relate to, for example: parameter filling; welcoming; payment taking; small talk confirmations; and destination related intent areas. Some of these skills/intent areas may be predefined as allowing automatic approval for updating predefined responses (e.g. knowledge base articles) associated with the intent. For example, parameter filling, welcoming, and small talk confirmations may be set for auto approval, with a corresponding system action that when identified as required improvement embodiments of the invention may automatically implement changes as described herein, such as suggesting an update to, or replacing, a predefined response stored in the knowledge base. However some skills/intent areas may not be auto approved, for example payment taking and destination related responses. This may be because of a greater risk and/or sensitivity of these areas. For example there may be regulations and/or security concerns which limit what information can be requested in relation to taking a payment. As another example, in the context of a flight booking bot, updates to the available destinations may need supervisor approval, because the gen AI may experience a hallucination and suggest non-existent destinations, and/or destinations to which flights are not available. For intents requiring improvement for which no auto approval is granted, the corresponding system action may be to send to a supervisor for approval.

Accordingly, embodiments of the invention may determine whether to automatically update a set of predefined responses of the chat bot based on at least one of the one or more identified skills and the chat bot effectiveness score (e.g. if the score has decreased since a last review, and/or if the skill/performance area has been pre-approved for automatic updates). Otherwise (e.g. if the score has remained the same or increased since a last review, and/or if the skill/performance area has not been pre-approved for automatic updates), embodiments may output an indication of the one or more identified skills and the chat bot effectiveness score, for example by sending to a supervisor terminal for a supervisor to review.

Returning to method 400 shown in FIG. 4, step 460 of outputting an indication of the one or more identified skills and the chat bot effectiveness score may include sending, e.g. to a manager/supervisor, a summary of the chat bot performance and a suggested update to the set of predefined responses of the chat bot for manual approval.

In some embodiments, at least one parameter of the chat bot may include a rating value determined based on a predefined range of rating values. For example, a rating may contextualize a parameter, because different parameters may be viewed as positive or negative depending on how large or small the value is. As an example, a low number of missed messages (e.g. less than or equal to 2) may generally be positive, but a low customer satisfaction score (e.g. 2 out of 5 stars) may generally be negative. Thus, using absolute values of MM=2 and CS=2 may give a misleading view of the chat bot performance. Rating thresholds may be defined to address this, for example for MM example rating thresholds may include: MM<20 a day=5; 20<MM<40=4; 40<MM<60=3; 60<MM<80=2; and MM>80=1.

According to some embodiments, at least one rating value may be weighted based on a predefined range of weighting values. For example, some parameters (and thus the associated assigned rating value) may be deemed to be more important than others, and may be weighted so as to contribute to a greater or lesser extent to the final score. For example, a weighting value of 5 may be applied to influential parameters, and a weighting value of 1 may be assigned to less influential parameters.

FIG. 6 shows example predefined ranges of rating values and weights, according to some embodiments of the invention. For example, for each parameter a rating determination based on the parameter value may be predefined, including a number of predefined rating values to assign based on a range in which the parameter value lies. For example, for total number of unique users, if the parameter value is 25, this may be mapped to a rating value of 2 based on a predefined threshold that if UU is >20 and <40 the determined rating value is 2, as shown in FIG. 6.

Parameters and/or rating values may be weighted, for example as shown in FIG. 6. Weights may be predefined by a supervisor based on a perceived importance of that parameter in the domain or context of the chat bot concerned (e.g. customer satisfaction may be a more important parameter, and thus attract a higher weight, for a complaints bot). A weight may take a value between 1 and 5, for example.

In FIG. 6, the weight for conversation length is shown as 3, and the weight for interaction rate is shown as 1. These may be parameters which have a low impact on the performance of the chat bot concerned. Conversely, the weights for total number of engaged conversations and missed messages are both 5, which may represent a higher degree of influence of these parameters on the performance of the chat bot.

The score for a parameter may be calculated as the product (e.g. multiplication) of the determined rating value for that parameter and the weight for that parameter. For example, for conversation length (CL) the determined rating value in FIG. 6 is 3 and the weight is 3, and thus the score for conversation length is 3× 3=9. Similarly, for missed messages (MM) the score for that parameter is calculated as 1×5=5. These may be representative values, e.g. representative of both of the rating and the weighting.

Assigning rating values may allow to establish a maximum score from which a percentage, fraction, and/or decimal value can be calculated. For example, the predefined range of rating values may have a maximum rating value, such as in the case of conversation length (CL) shown in FIG. 6 the maximum rating value is 4, whereas the maximum rating value of, say, missed messages (MM) is 5. Based on the assigned weighting, this can result in a so-called max score for that parameter, for example as the product of the max rating value and the weighting value. Thus, the max score for CL is 12 (4×3) and for MM is 25 (5×5). These max scores can be compared to the actual scores calculated above of 9 and 5 respectively, and thereby give some measure of the overall performance of the chat bot in these parameter areas.

Calculating all the values in the table of FIG. 6 as described (e.g. Sum of the product of assigned rating value and assigned weight for each parameter) gives an achieved score of 86 out of a max score of 207. The VCBES may thus be expressed as 86/207=0.42.

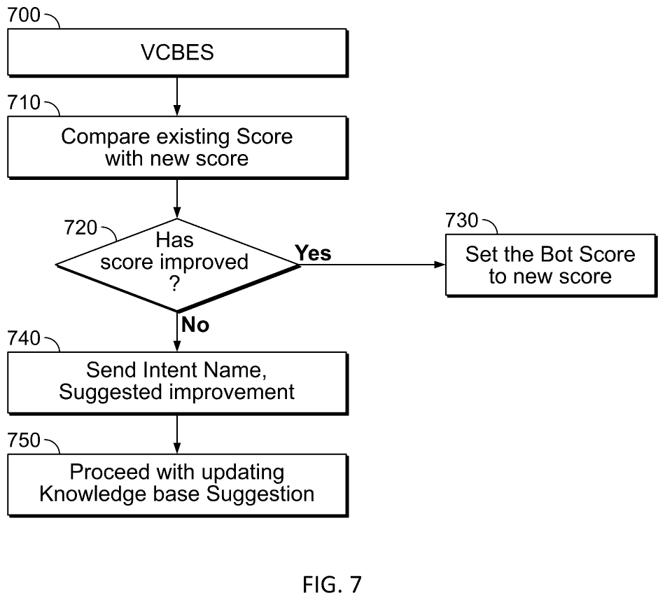

FIG. 7 shows a schematic example of how a score may be used, according to some embodiments of the invention. For example, a calculated VCBES 700, calculated as described herein, may be compared (710) with an existing score. A determination as to whether the score has improved may be made (720). For example if the new score is higher this may indicate an improvement.

If the score has improved, embodiments of the invention may set the bot score as the new score (730). For example, a database which relates different bots to their respective scores may be updated with the new score.

If the score has not improved, embodiments of the invention may analyze a transcript of the bot as described herein to identify an intent or performance area/skill which requires improvement, and may send this with a suggested improvement (740), for example to an aggregator and/or supervisor as described in FIG. 2A. Embodiments of the invention may proceed with updating knowledge base suggestions (750), for example as described in FIG. 2A.

Some embodiments of the invention may relate to a method for monitoring an effectiveness of a chat bot. For example, a method may include determining, using artificial intelligence (AI) and based on a conversation of the chat bot, a desired area of improvement of the chat bot. The desired area of improvement may relate to a skill, ability, or performance area of the chat bot that is determined to be lacking. For example, based on an AI analysis of a transcript of a conversation in which the chat bot participates it is determined that an ability of the chat bot to handle repeated errors of the customer gracefully is an area which requires improvement.

An intent which requires improvement, such as parameter filling, payment taking, small talk, or the like may be examples of desired areas of improvement, for example a determined desired area of improvement may be determined based on an intent of a user of the chat bot to which the transcript pertains.

Some embodiments of the invention may include calculating a chat bot effectiveness score, and automatically updating a set of knowledge base articles of the chat bot based on a predefined threshold of the chat bot effectiveness score. The chat bot effectiveness score may be calculated as described herein. Calculating the chat bot effectiveness score may include determining a representative value for one or more parameters of the chat bot, such as a rating value as described with respect to FIG. 6. The representative value of a parameter may be a rating value multiplied by a weighting value. In some embodiments, calculating the chat bot effectiveness score includes summing the determined representative values.

The chat bot effectiveness score may be related to the desired area of improvement in that the chat bot effectiveness score may include a parameter which directly or indirectly measures the desired area of improvement. For example a missed messages (MM) parameter may directly or indirectly characterize the ability/skill of the chat bot to use conversational clues to identify what the customer is trying to convey. If the AI identifies that the chat bot is not understanding the intent of the customer, the score may be calculated in such a way as to include the MM parameter, for example by using EQN. 1 which includes the MM parameter.

In some embodiments, the step of automatically updating includes generating, by the AI, a replacement knowledge base article based on the determined desired area of improvement. Automatically updating may include modifying or retraining AI used by a chat bot.

Reference is now made to FIG. 8, which is a block diagram of an exemplary computing device 800 which may be used with embodiments of the present invention.

Computing device 800 may include a controller or processor 805 that may be, for example, a central processing unit processor (CPU), a chip or any suitable computing or computational device, an operating system 815, a memory 820, a storage 830, input devices 835 and output devices 840.

Operating system 815 may be or may include any code segment designed and/or configured to perform tasks involving coordination, scheduling, arbitration, supervising, controlling or otherwise managing operation of computing device 800, for example, scheduling execution of programs. Memory 820 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 820 may be or may include a plurality of, possibly different, memory units. Memory 820 may store for example, instructions to carry out a method (e.g., code 825), and/or data such as example method 400, one or more scores, one or more rating values and/or one or more weighting values.

Executable code 825 may be any executable code, e.g., an application, a program, a process, task or script. Executable code 825 may be executed by controller 805 possibly under control of operating system 815. In some embodiments, more than one computing device 800 or components of device 800 may be used for multiple functions and devices described herein; for example a chat bot, a patron computer, Gen AI 253, and other modules or devices may be or include computers such as depicted in FIG. 8. For the various modules and functions described herein, one or more computing devices 800 or components of computing device 800 may be used. Devices that include components similar or different to those included in computing device 800 may be used, and may be connected to a network and used as a system. One or more processor(s) 805 may be configured to carry out embodiments of the present invention by, for example, executing software or code. Storage 830 may be or may include, for example, a hard disk drive, a floppy disk drive, a Compact Disk (CD) drive, a CD-Recordable (CD-R) drive, a universal serial bus (USB) device or other suitable removable and/or fixed storage unit. Storage 830 may include cloud-based storage. Storage 830 may include database storage. In some embodiments, some of the components shown in FIG. 8 may be omitted.

Input devices 835 may be or may include a mouse, a keyboard, a touch screen or pad or any suitable input device. It will be recognized that any suitable number of input devices may be operatively connected to computing device 800 as shown by block 835. Output devices 840 may include one or more displays, speakers and/or any other suitable output devices. It will be recognized that any suitable number of output devices may be operatively connected to computing device 800 as shown by block 840. Any applicable input/output (I/O) devices may be connected to computing device 800, for example, a wired or wireless network interface card (NIC), a modem, printer or facsimile machine, a universal serial bus (USB) device or external hard drive may be included in input devices 835 and/or output devices 840.

Embodiments of the invention may include one or more article(s) (e.g., memory 820 or storage 830) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

A system for carrying out embodiments of the invention, such as a system for monitoring a performance of a chat bot, may include at least one computer processor (e.g. such as a computing device 800) and a memory containing instructions which, when executed by the at least one computer processor, cause the at least one computer processor to carry out one or methods as described herein, such as method 400.

For example, the computer processor may: analyze, e.g. by executing an artificial intelligence (AI) module, a transcript of at least one conversation of the chat bot; identify, by executing the AI module, one or more skills of the chat bot where performance falls below a pre-defined performance threshold; determine a chat bot effectiveness score; and determine whether to: automatically update a set of predefined responses of the chat bot based on at least one of: the one or more identified skills; and the chat bot effectiveness score, else, output an indication of the one or more identified skills and the chat bot effectiveness score.

The at least one computer processor may be configured to determine the chat bot effectiveness score as given in EQN. 1. The at least one computer processor may be configured to generate, e.g. by executing the AI module, one or more recommended responses to be added to the set of predefined responses, or for updating a response of the set of predefined responses.

The at least one computer processor may be configured to reformat the transcript of the at least one conversation of the chat bot prior to analysing.

Embodiments of the invention may improve the technologies of chat bots, by using specific algorithms to efficiently analyze and summarize large pools of data, such as chat bot transcripts to identify parameter values, a task which is impossible, in a practical sense, for a person to carry out.

As described herein, an artificial intelligence, generative artificial intelligence, and/or large language model (LLM) may be, or may include elements of, a machine learning model and/or artificial neural network, and may receive input data. An AI module according to embodiments of the invention may output suggestions determined on the basis of function approximation and/or regression analysis.

An artificial neural network may include neurons or nodes organized into layers, with links between neurons transferring output between neurons. Aspects of a neural network may be weighed, e.g. links may have weights, and training may involve adjusting weights. A positive weight may indicate an excitatory connection, and a negative weight may indicate an inhibitory connection. A neural network may be executed and represented as formulas or relationships among nodes or neurons, such that the neurons, nodes, or links are “virtual”, represented by software and formulas, where training or executing a neural network is performed, for example, by a conventional computer or Graphical Processing Unit (GPU), such as computing device 800 in FIG. 8.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include zero, one, or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for monitoring a performance of a chat bot, the method comprising:
analysing, by an artificial intelligence (AI) module, a transcript of at least one conversation in which the chat bot participates;
identifying, by the AI module, one or more skills of the chat bot where performance of the skills falls below a pre-defined performance threshold;
determining a chat bot effectiveness score; and
determining whether to:
automatically update a set of predefined responses of the chat bot based on at least one of:
the one or more identified skills; and
the chat bot effectiveness score,
else, outputting an indication of the one or more identified skills and the chat bot effectiveness score.

2. The method of claim 1, wherein the chat bot effectiveness score is based on at least one parameter of the chat bot selected from the list comprising:
an average conversation length (CL);
an interaction rate (IR);
a total number of conversations (TC);
a total number of engaged conversations (EC);
a total number of unique users (UU);
a missed messages (MM) parameter;
a human takeover rate (TR);
a goal completion rate (CR);
a customer satisfaction score (CS); and
an average response time (RT).

3. The method of claim 2, wherein the chat bot effectiveness score is defined as:
$$Effectivness Score = {\sum }_{k = 0}^{TC} CL + IR + EC + UU + MM + TR + CR + CS + RT$$
wherein k is an index of a conversation of a total number of conversations of the chat bot.

4. The method of claim 3, wherein at least one parameter of the chat bot comprises a rating value determined based on a predefined range of rating values.

5. The method of claim 4, wherein at least one rating value is weighted based on a predefined range of weighting values.

6. The method of claim 1, comprising generating, by the AI module, one or more recommended responses to be added to the set of predefined responses, or for updating a response of the set of predefined responses.

7. The method of claim 1, comprising reformatting the transcript of the at least one conversation of the chat bot prior to analysing by the AI module.

8. A system for monitoring a performance of a chat bot, the system comprising:
at least one computer processor; and
a memory containing instructions which, when executed by the at least one computer processor, cause the at least one computer processor to:
analyze, by executing an artificial intelligence (AI) module, a transcript of at least one conversation of the chat bot;
identify, by executing the AI module, one or more skills of the chat bot where performance of the skills falls below a pre-defined performance threshold;
determine a chat bot effectiveness score; and
determine whether to:
automatically update a set of predefined responses of the chat bot based on at least one of:
the one or more identified skills; and
the chat bot effectiveness score,
else, output an indication of the one or more identified skills and the chat bot effectiveness score.

9. The system of claim 8, wherein the chat bot effectiveness score is based on at least one parameter of the chat bot selected from the list comprising:
an average conversation length (CL);
an interaction rate (IR);
a total number of conversations (TC);
a total number of engaged conversations (EC);
a total number of unique users (UU);
a missed messages (MM) parameter;
a human takeover rate (TR);
a goal completion rate (CR);
a customer satisfaction score (CS); and
an average response time (RT).

10. The system of claim 9, wherein the at least one computer processor is configured to determine the chat bot effectiveness score as:
$$Effectivness Score = {\sum }_{k = 0}^{TC} CL + IR + EC + UU + MM + TR + CR + CS + RT$$
wherein k is an index of a conversation of a total number of conversations of the chat bot.

11. The system of claim 10, wherein at least one parameter of the chat bot comprises a rating value determined based on a predefined range of rating values.

12. The system of claim 11, wherein at least one rating value is weighted based on a predefined range of weighting values.

13. The system of claim 8, wherein the at least one computer processor is configured to generate, by executing the AI module, one or more recommended responses to be added to the set of predefined responses, or for updating a response of the set of predefined responses.

14. The system of claim 8, wherein the at least one computer processor is configured to reformat the transcript of the at least one conversation of the chat bot prior to analysing.

15. A method for monitoring an effectiveness of a chat bot, the method comprising:
determining, using artificial intelligence (AI) and based on a conversation of the chat bot, a desired area of improvement of the chat bot;
calculating a chat bot effectiveness score; and
automatically updating a set of knowledge base articles of the chat bot based on a predefined threshold of the chat bot effectiveness score.

16. The method of claim 15, wherein the determined desired area of improvement is determined based on an intent of a user of the chat bot to which the transcript pertains.

17. The method of claim 15, wherein the step of automatically updating comprises generating, by the AI, a replacement knowledge base article based on the determined desired area of improvement.

18. The method of claim 15, wherein calculating the chat bot effectiveness score comprises determining a representative value for one or more parameters of the chat bot.

19. The method of claim 18, wherein the one or more parameters comprises at least one of:
an average conversation length (CL);
an interaction rate (IR);
a total number of conversations (TC);
a total number of engaged conversations (EC);
a total number of unique users (UU);
a missed messages (MM) parameter;
a human takeover rate (TR);
a goal completion rate (CR);
a customer satisfaction score (CS); and
an average response time (RT).

20. The method of claim 18, wherein calculating the chat bot effectiveness score comprises summing the determined representative values.
